(19) United States
(12) Patent Application Publication
(10) Pub. No.: US 2026/0316268 A1
(43) Pub. Date: Oct. 15, 2026

(54) CONTROLLING ROBOTS USING LANGUAGE MODEL GENERATED PROGRAMS

(71) Applicant: Google LLC, Mountain View, CA (US)

(72) Inventors: Andy Zeng, Stanford, CA (US); Qiao Liang, Pittsburgh, PA (US); Peter Raymond Florence, San Francisco, CA (US)

(21) Appl. No.: 19/112,018

(22) PCT Filed: Sep. 18, 2023
(86) PCT No.: PCT/US2023/033047

§ 371 Date: Mar. 14, 2025

Related U.S. Application Data
(60) Provisional application No. 63/407,607, filed on Sep. 16, 2022.

(51) Int. Cl. B25J 9/16; B25J 13/00

(52) U.S. Cl. CPC B25J 9/1658; B25J 9/161; B25J 9/163; B25J 13/003

(57) ABSTRACT

Methods, systems, and apparatus, including computer programs encoded on a computer storage medium, for controlling a robot using language model programs. A language model program is computer program generated from an output of a code generation neural network, e.g., one that has been trained on a language modeling objective on computer code data.

### CROSS-REFERENCE TO RELATED APPLICATION

This application claims priority to U.S. Application No. 63/407,607, filed Sep. 16, 2022, the disclosure of which is incorporated herein by reference.

### BACKGROUND

This specification relates to controlling robots via language and using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls a robot interacting with an environment using language model generated programs (LMPs).

Particular embodiments of the subject matter described in this specification can be implemented so as to realize one or more of the following advantages.

Providing users the ability to control robots using natural language instructions can be desirable for many types of robotics tasks.

However, implementing a policy that successfully causes a robot to follow an arbitrary user instruction is difficult. In particular, robots that use language need it to be grounded (or situated) to reference the physical world and bridge connections between words, percepts, and actions.

Some conventional methods ground language using lexical analysis to extract semantic representations that inform policies, but these techniques struggle to handle unseen instructions.

Other methods learn the grounding end-to-end (language to action), but these techniques require copious amounts of training data, which can be expensive to obtain on real-world robots.

This specification, on the other hand, describes techniques for using a pre-trained code generation neural network, e.g., a language model pre-trained on computer code data, to generate robot policy code (“language model generated programs”) given natural language commands. In particular, the generated code can express functions or feedback loops that process perception outputs (e.g., outputs of open vocabulary object detectors) and parameterize control primitive APIs for controlling the robot. In particular, the LMPs can take in new natural language commands and autonomously re-compose the available API calls to generate new policy code that carries out the commands. Thus, the described system can generalize to new instructions and can operate on arbitrary sets of available APIs, allowing the outputs of the system to move the robot in the environment as well as generate natural language text responses to questions posed in the natural language instructions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example robot policy system.

FIG. 2 is a flow diagram of an example process for controlling the robot.

FIG. 3 is a flow diagram of an example process for generating a computer program from an output sequence.

FIG. 4 shows an example of an LMP.

Like reference numbers and designations in the various drawings indicate like elements.

### DETAILED DESCRIPTION

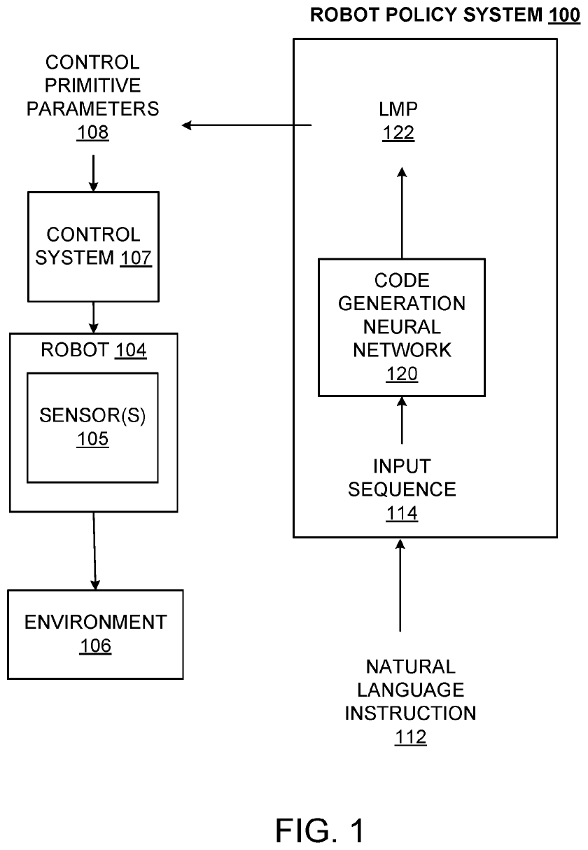

FIG. 1 shows an example robot policy system 100. The robot policy system 100 is an example of a system implemented as computer programs on one or more computers in one or more locations in which the systems, components, and techniques described below are implemented.

The robot policy system 100 controls a robot 104 interacting with an environment 106 to accomplish tasks.

The robot 104 can be any appropriate type of robot, e.g., e.g., a robotic arm, a humanoid robot, a quadruped robot, a vehicular robot, e.g., an autonomous vehicle, and so on.

As a general example, the task can include one or more of, e.g., navigating to a specified location in the environment, identifying a specific object in the environment, manipulating the specific object in a specified way, and so on.

In some cases, and as will be described below, the task is specified by a natural language instruction 122 that is received by the system 100.

The robot 104 generally has one or more sensors 105 that sense the environment, e.g., one or more of the following: camera sensors, laser sensors, radar sensors, temperature sensors, microphone sensors, proprioceptive sensors, e.g., optical encoders, gyroscopes, gyroscopes, accelerometers, inertial measurement units, and so on, etc.

The robot 104 generally also has software that processes readings from these sensors to generate outputs, e.g., machine learning models or other software that detects, localizes, or otherwise characterizes objects in the environment. For example, the robot 104 can have machine learning models that perform object localization, that perform open-vocabulary object detection, and so on.

The robot 104 is controlled by specifying parameters 108 for one or more control primitives. A control primitive is a function that maps a set of parameters to a sequence of one or more control inputs to the robot. For example, a control primitive can be a function that maps parameters that specify a target angular velocity for the robot to a sequence of control inputs that cause the robot to have target angular velocity. As another example, another control primitive can be a function that maps a set of parameters that specify an initial location of an object and a final location of the object to a sequence of control inputs that cause the robot to move the object from the initial location to the final location. As another example, another control primitive can be a function that maps a set of parameters that specify an initial location of a gripper of a robot object and a final location of the gripper to a sequence of control inputs that cause the robot to move the gripper from the initial location to the final location. As another example, another control primitive can be a function that maps a set of parameters that specify an initial location of a gripper of a robot object and a final location of the gripper to a sequence of control inputs that cause the robot to move the gripper from the initial location to the final location.

A control system 107 for the robot 104 then maps these control primitive parameters 108 into control inputs for one or more controllable elements of the robot, e.g., position, velocity, or force/torque/acceleration data for one or more joints or other control elements of the robot. That is, the control system 107 performs the function specified by the control primitive 108 to map the set of parameters to the corresponding sequence of control inputs.

In other words, the system 100 has access to a set of control primitives for the robot 104 that each map a respective set of parameters to a set of control inputs for the robot 104. By providing the control primitive parameters 108 for a given control primitive to the control system 107, the system 100 can cause the control system 107 to map the parameters 108 to control inputs for the robot and thereby control the robot 104.

More specifically, the system 100 controls the robot through language model generated programs (LMPs) 122.

An LMP 122 is a computer program generated from a computer code sequence generated as output by a code generation neural network 120.

A code generation neural network 120 is a neural network that receives an input sequence of tokens in a vocabulary for a programming language, e.g., Python, C++, C, or another programming language, and processes the input sequence to generate an output sequence of tokens in the vocabulary that specifies a computer program in the programming language.

For example, the code generation neural network 120 can have been trained on a language modeling objective on a corpus of training computer code sequences from training computer programs. That is, the code generation neural network 120 can have been trained on a next token prediction task that requires the neural network 120 to predict the next token in a computer code sequence given the preceding tokens in the computed code sequence.

As a particular example, the code generation neural network 120 can have the architecture of an auto-regressive language model neural network.

The language model neural network is referred to as an auto-regressive neural network because the neural network auto-regressively generates an output sequence of tokens by generating each particular token in the output sequence conditioned on a current input sequence that includes any tokens that precede the particular text token in the output sequence, i.e., the tokens that have for already been generated for any previous positions in the output sequence that precede the particular position of the particular token, and a context input that provides context for the output sequence. For example, the current input sequence when generating a token at any given position in the output sequence can include the context sequence and the tokens at any preceding positions that precede the given position in the output sequence. As a particular example, the current input sequence can include the context sequence followed by the tokens at any preceding positions that precede the given position in the output sequence. Optionally, the context and the current output sequence can be separated by one or more predetermined tokens within the current input sequence.

More specifically, to generate a particular token at a particular position within a candidate output sequence, the neural network 120 can process the current input sequence to generate a score distribution, e.g., a probability distribution, that assigns a respective score, e.g., a respective probability, to each token in the vocabulary of tokens. The neural network 120 can then select, as the particular token, a token from the vocabulary using the score distribution. For example, the neural network 120 can greedily select the highest-scoring token or can sample, e.g., using nucleus sampling or another sampling technique, a token from the distribution.

As a particular example, the language model neural network 120 can be an auto-regressive Transformer-based neural network that includes (i) a plurality of attention blocks that each apply a self-attention operation and (ii) an output subnetwork that processes an output of the last attention block to generate the score distribution.

The neural network 120 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai. K. Millican, J. Hoffmann. H. F. Song. J. Aslanides. S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro. A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger. I. Gabriel, W. S. Isaac. E. Lockhart, S. Osindero, L. Rimell. C. Dyer, O. Vinvals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee. Sharan Narang, Michael Matena, Yanqi Zhou, Wei Li. and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates at least the hidden state for the last token in the given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the neural network 120 is auto-regressive, the system 100 can use the same neural network 110 to generate multiple different candidate output sequences in response to the same request, e.g., by using beam search decoding from score distributions generated by the neural network 110, using a Sample-and-Rank decoding strategy, by using different random seeds for the pseudo-random number generator that's used in sampling for different runs through the neural network 120 or using another decoding strategy that leverages the auto-regressive nature of the neural network.

To control the robot 104, the system 100 obtains a natural language instruction 112 for interacting with the robot 104.

For example, the system 100 can receive the instruction 112 as input, e.g., as text or audio input, from a user that desires to cause the robot 104 to navigate through the environment or to obtain information generated as a result of navigation of the robot through the environment.

For example, the instruction 112 can be an instruction for the robot 104 to move an object to a specified location in the environment, to navigate to a specified location in the environment, to locate a specified object in the environment, or to respond to a query about the environment.

The system 100 generates an input sequence 114 that includes (i) the natural language instruction 112, i.e., represented as tokens from the vocabulary, and (ii) a context sequence that specifies one or more application programming interfaces (APIs) that can be called to obtain outputs generated by processing readings from the one or more sensors of the robot, to control the robot, or both. For example, the natural language instruction can be formatted as a comment in an input sequence of code.

That is, the APIs can include one or more APIs for querying specific types of information obtained from sensor readings and one or more APIs for parameterizing the control primitives that are used to control the robot.

The system processes the input sequence using the code generation neural network 120 to generate as output a computer code sequence in the programming language that defines a computer program for interacting with the robot.

Generally, the computer code sequence includes computer code representing a call to one of the one or more of the APIs and arguments for the call. That is, by virtue of the context sequence having been included in the input sequence, the code generation neural network 120 is able to generate an output sequence that makes use of the APIs to obtain information from the environment, to control the robot, or both.

The system 100 generates, from the computer code sequence, the computer program, i.e., the LMP 122, and then executes the computer program to interact with the robot. As described in more detail below, generating, from the computer code sequence, the computer program, may include, for example, one or more of conforming the code sequence to a syntax for an execution function or performing hierarchical function generation by parsing a code block's abstract syntax tree and checking for functions that do not exist in the given scope.

Interacting with the robot may comprise controlling the robot. Depending on the API call(s) included in the computer code sequence, controlling the robot may comprise causing the robot to move in an environment, and/or may comprise causing information derived from sensor readings to be retrieved. That is, when the computer code sequence includes an API call to an API that parameterizes the control primitives, executing the computer program causes the robot to move in the environment. When the computer code sequence includes an API call to an API that provides information derived from sensor readings, executing the computer program causes the information to be retrieved and processed according to the remainder of the sequence.

In some cases. e.g., when the instruction 112 includes a question about the environment, the LMP 122 can return a natural language response. The system 100 can then provide the response to the user that submitted the instruction 112, e.g., as natural language text or as speech using a text-to-speech engine.

As will be understood by those skilled in the art, executing the computer program to interact with the robot may comprise causing one or more control inputs for one or more controllable elements of the robot to be generated (e.g. by the control system 107). The control inputs generated by the control system 107 to control the robot can include, e.g., torques for the joints of the robot or higher-level control commands. In other words, the control inputs can include for example, position, velocity, or force/torque/acceleration data for one or more joints of a robot or parts of another mechanical agent. Control inputs may additionally or alternatively include electronic control data such as motor control data, or more generally data for controlling one or more electronic devices within the environment the control of which has an effect on the observed state of the environment.

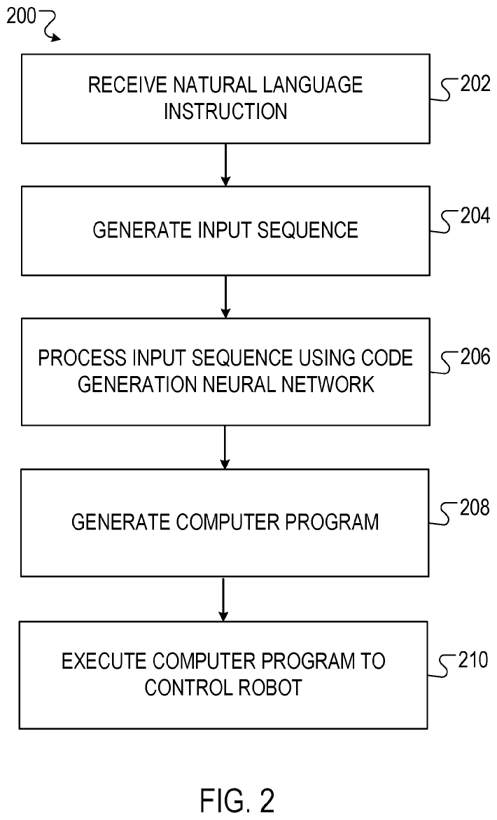

FIG. 2 is a flow diagram of an example process 200 for controlling the robot. For convenience, the process 200 will be described as being performed by a system of one or more computers located in one or more locations. For example, an robot policy system, e.g., the robot policy system 100 of FIG. 1, appropriately programmed in accordance with this specification, can perform the process 200.

The system obtains a natural language instruction for interacting with the robot (step 202).

The system generates an input sequence that includes (i) the natural language instruction, and (ii) a context sequence that specifies one or more application programming interfaces (APIs) that can be called to obtain outputs generated from one or more sensors of the robot, to control the robot, or both (step 204).

In some implementations, the context sequence includes a k-shot prompt, where k is an integer greater than or equal to one. In other words, the input sequence further includes k, i.e., one or more, example sequences that each include (i) an example natural language instruction, and (ii) an example computer code sequence in the programming language generated in response to the example natural language instruction. Generally, the example computer code sequences will include calls to the APIs to control the robot and calls to the APIs to obtain outputs from the one or more sensors of the robot. By including the k-shot prompt in the input sequence, the system provides the code generation neural network information about what APIs are available to be called and examples of how the APIs can be used to carry out the natural language input. As described above, the example natural language instruction in each example can be formatted as a code comment. One simplified example of a one-shot prompt can be as follows:

# if you see an orange, move backwards.
if detect_object(“orange”):
robot.set_velocity(x=−0.1, y=0, z=0)

where “# if you see an orange, move backwards” is an example natural language instruction formatted as commented code. “detect object(“orange”) is a call to an API that performs open-vocabulary object detection in images captured by sensors of the robot, and “robot.set_velocity(x=−0.1, y=0, z=0)” is a call to a control primitive API that sets the angular velocity of the robot to the parameters specified in the call, i.e., with the parameters being the x velocity −0.1, the y velocity 0, and the z velocity 0.

In the simplified example above, the natural language instruction obtained by the system 100 could for example comprise “move rightwards until you see the apple”. The API call specified in the context sequence may then be re-composed by the pre-trained code generation neural network 120 to generate a computer code sequence as follows:

while not detect_object(“apple”):
robot.set_velocity(x=0, y=0.1, z=0)

In some implementations, instead of or in addition to the k-shot prompt, the context sequence can include text that identifies each of the APIs and provides a natural language description of the function of each of the APIs, e.g., also formatted as a code comment.

In some implementations, instead of in addition to the above, the context sequence can include code that is formatted as import statements that inform the neural network which APIs are available and type hints on how to use those APIs.

In some implementations, the natural language instruction can be a follow-up natural language instruction that follows a preceding instruction (and corresponding movement/control of the robot). In these implementations, the input sequence can also include the preceding natural language instruction and the output sequence generated for the preceding natural language instruction. This can allow the code generation neural network to generate programs that use context from previously generated programs and allow users to submit feedback that results in modification to the control of the robot.

The system processes the input sequence using a code generation neural network to generate as output a computer code sequence in a programming language that defines a computer program (step 206). Generally, the computer code sequence includes computer code representing a call to one of the one or more APIs and arguments for the call.

In some cases, because the code generation neural network has been pre-trained on a code prediction task as described above, the computer code sequence can also include code that represents a call to a library for the programming language that is not specified in the context sequence, e.g., by using NumPy or other similar libraries to elicit spatial reasoning with coordinates.

The system generates, from the computer code sequence, the computer program (step 208) and then executes the computer program to interact with the robot (step 210). In this way, the system may control the robot in accordance with the computer program.

To execute the computer program, the system can call an execution function for the programming language with an input string derived that is derived from the computer code sequence, e.g., with an input string that formats the computer code sequence according to a syntax for the execution function.

More specifically, the system can call the execution function with the input string and with (i) a global dictionary that specifies the one or more APIs and (ii) a local dictionary that can be populated with variables defined during the execution.

The local dictionary can be initialized as empty when the execution function is called and can be populated with values as the computer program is executed. For some natural language instructions, after the computer program has been executed, the system can provide one or more values from the local dictionary in response to the natural language instruction.

For example, the natural language instruction may include a request for the system to provide information about the environment to the user, e.g., from whom the natural language instruction was received. As part of executing the program, the system populates the local dictionary with the values that are specified in the request for information and, after execution, the system can provide the one or more values in response to the request. For example, the generated program can include a call to an API that outputs text and that parameterizes the call with one or more values stored in the local dictionary.

In some implementations, prior to executing the computer program, the system can first check to ensure that the computer program is safe to run. For example, the system can verify that there are no import statements, calls to certain functions that have been deemed risky, e.g., the “eval” or “exec” function in Python, or no special variables, e.g., variables that begin with “______” in a Python program.

Additionally, in some implementations, the system generates computer programs that are hierarchical.

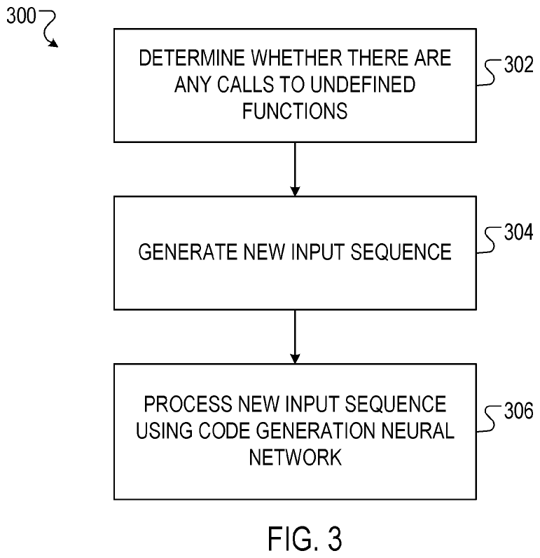

This is described in more detail below with reference to FIG. 3.

FIG. 3 is a flow diagram of an example process 300 for generating a computer program from an output sequence. For convenience, the process 300 will be described as being performed by a system of one or more computers located in one or more locations. For example, an robot policy system, e.g., the robot policy system 100 of FIG. 1, appropriately programmed in accordance with this specification, can perform the process 300.

The system can continue performing the process 300 until the computer code sequence does not include any functions that are undefined. Once the computer code sequence no longer includes undefined functions, the system can execute the computer program defined by the code sequences and the additional function definitions as described above.

The system determines whether the computer code sequence includes any computer code that calls a function that is undefined (step 302).

That is, the system identifies all of the function calls in the computer code sequence and then determines whether any of the function calls call a function that has not been defined, e.g., in a library for the programming language, within the computer code sequence, or within the local dictionary.

For example, in Python, the system can parse a code block's abstract syntax tree to check for functions that do not exist in the given scope.

When the system identifies a function call that calls an undefined function, the system generates a new input sequence that includes a natural language instruction to define the function (step 304).

For example, the new input sequence can include a natural language instruction “# define function: get_obj_bbox_area(obj_name),” where “get_obj_bbox_area(obj_name)” is the name of the function that was called in the computer code sequence and was determined to be undefined.

In some implementations, the new input sequence also includes one or more of the natural language instruction, the context sequence, or the output sequence generated by the code generation neural network. This can provide context to the code generation neural network for generating the definition of the undefined function.

The system then processes the new input sequence using the code generation neural network to generate a new output sequence that includes new computer code that defines the function (step 306).

The system then adds the new computer code that defines the function to the scope of the program. For example, the system can add data specifying the new computer code that defines the function to the global dictionary, the local dictionary, or both. As another example, the system can generate a modified computer code sequence that replaces the first computer code with the new computer code.

The system can then repeat the process 300 on the code that defines the function, e.g., to ensure that the function definition does not itself call any undefined function and, if not, that the code generation neural network is used to define the function. The system can continue performing iterations of the process 300 until all of the functions in the output sequence and all of the functions in the new output sequences have definitions.

Thus, in this manner, the system can implement hierarchical program generation, which allows the code generation neural network to hierarchically generate complex programs that when executed successfully cause the robot to respond to the natural language instruction. For example, the programs can sequence control primitives or build action trajectories.

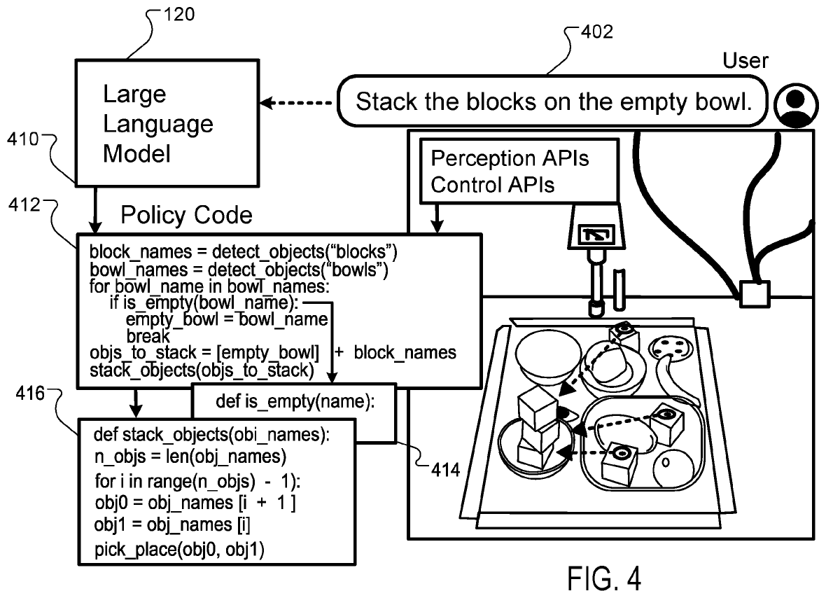

FIG. 4 shows an example 400 of a LMP 410 generated by the code generation neural network in response to a natural language instruction 402.

In the example of FIG. 4, the instruction 402 is “Stack the blocks on the empty bowl.”

As shown in FIG. 4, the system processes an input sequence that includes the instruction 402 using the code generation neural network 120 to generate the LMP 410 written in Python.

As can be seen from the example, the LMP 410 calls several APIs. For example, the LMP 410 includes two API calls to an API that provides perception outputs (“detect objects”) and an API call to an API that parameterizes control primitives for the robot (“pick_place”).

Additionally, in the example of FIG. 4, the code generation neural network 120 has generated the LMP 410 hierarchically. In particular, an initial sequence 412 generated by the neural network 120 includes calls to two undefined functions: “is_empty” and “stack_objects.” In response to determining that these functions are undefined, the system has used the neural network 120 to generate new sequences 414 and 416 that define each of the functions. As can be seen from FIG. 4, the new sequences 416 that defines the “stack_objects” function includes a call to the API that parameterizes control primitives. Thus, the system has hierarchically generated a complex string of control inputs for the robot that causes the robot stack multiple blocks on the empty bowl.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM. EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device. e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method for controlling a robot, the method comprising:
obtaining a natural language instruction for interacting with the robot;
generating an input sequence that comprises:
(i) the natural language instruction, and
(ii) a context sequence that specifies one or more application programming interfaces (APIs) that can be called to obtain outputs generated from one or more sensors of the robot, to control the robot, or both;
processing the input sequence using a code generation neural network to generate as output a computer code sequence in a programming language that defines a computer program, the computer code sequence comprising computer code representing a call to one of the one or more APIs and arguments for the call;
generating, from the computer code sequence, the computer program; and
executing the computer program to interact with the robot.

2. The method of claim 1, wherein the input sequence further comprises one or more example sequences that each comprise:
(i) an example natural language instruction, and
(ii) an example computer code sequence in the programming language generated in response to the example natural language instruction.

3. The method of claim 1, wherein generating, from the computer code sequence, the computer program comprises:
determining that the computer code sequence includes first computer code that calls a function that is undefined; and
in response:
generating a new input sequence that comprises a natural language instruction to define the function; and
processing the new input sequence using the code generation neural network to generate a new output sequence that comprises new computer code that defines the function.

4. The method of claim 3, wherein generating, from the computer code sequence, the computer program comprises:
generating a modified computer code sequence that replaces the first computer code with the new computer code.

5. The method of claim 1, wherein executing the computer program to interact with the robot comprises:
calling an execution function for the programming language with an input string derived from the computer code sequence.

6. The method of claim 5, wherein calling the execution function further comprises:
calling the execution function with:
(i) a global dictionary that specifies at least the one or more APIs, and
(ii) a local dictionary that can be populated with at least variables defined during the execution.

7. The method of claim 6, the method further comprising:
after executing the computer program, providing one or more values from the local dictionary in response the natural language instruction.

8. The method of claim 3, wherein generating the computer program comprises adding data specifying the new computer code that defines the function to a global dictionary, a local dictionary, or both.

9. The method of claim 1, wherein the computer code sequence comprises computer code representing a call to a library for the programming language that is not specified in the context sequence.

10. The method of claim 1, wherein the code generation neural network is an auto-regressive neural network that auto-regressively generates each computed code token in the computer code sequence conditioned on the input sequence.

11. The method of claim 10, wherein the code generation neural network is a Transformer neural network.

12. The method of claim 1, wherein the code generation neural network has been trained on a language modeling objective on a corpus of training computer code sequences from training computer programs.

13. (canceled)

14. One or more non-transitory computer storage media storing instructions that when executed by one or more computers cause the one or more computers to perform operations for controlling a robot, the operations comprising:
obtaining a natural language instruction for interacting with the robot;
generating an input sequence that comprises:
(i) the natural language instruction, and
(ii) a context sequence that specifies one or more application programming interfaces (APIs) that can be called to obtain outputs generated from one or more sensors of the robot, to control the robot, or both:
processing the input sequence using a code generation neural network to generate as output a computer code sequence in a programming language that defines a computer program, the computer code sequence comprising computer code representing a call to one of the one or more APIs and arguments for the call;
generating, from the computer code sequence, the computer program; and
executing the computer program to interact with the robot.

15. A system comprising one or more computers and one or more storage devices storing instructions that when executed by the one or more computers cause the one or more computers to perform operations for controlling a robot, the operations comprising:
obtaining a natural language instruction for interacting with the robot;
generating an input sequence that comprises:
(i) the natural language instruction, and
(ii) a context sequence that specifies one or more application programming interfaces (APIs) that can be called to obtain outputs generated from one or more sensors of the robot, to control the robot, or both;
processing the input sequence using a code generation neural network to generate as output a computer code sequence in a programming language that defines a computer program, the computer code sequence comprising computer code representing a call to one of the one or more APIs and arguments for the call;
generating, from the computer code sequence, the computer program; and
executing the computer program to interact with the robot.

16. The system of claim 15, wherein the input sequence further comprises one or more example sequences that each comprise:
(i) an example natural language instruction, and
(ii) an example computer code sequence in the programming language generated in response to the example natural language instruction.

17. The system of claim 15, wherein generating, from the computer code sequence, the computer program comprises:
determining that the computer code sequence includes first computer code that calls a function that is undefined; and
in response:
generating a new input sequence that comprises a natural language instruction to define the function; and
processing the new input sequence using the code generation neural network to generate a new output sequence that comprises new computer code that defines the function.

18. The system of claim 17, wherein generating, from the computer code sequence, the computer program comprises:
generating a modified computer code sequence that replaces the first computer code with the new computer code.

19. The system of claim 15, wherein executing the computer program to interact with the robot comprises:
calling an execution function for the programming language with an input string derived from the computer code sequence.

20. The system of claim 19, wherein calling the execution function further comprises:
calling the execution function with:
(i) a global dictionary that specifies at least the one or more APIs, and
(ii) a local dictionary that can be populated with at least variables defined during the execution.

21. The system of claim 20, the method further comprising:
after executing the computer program, providing one or more values from the local dictionary in response the natural language instruction.
